(19) United States
(12) Patent Application Publication
(10) Pub. No.: US 2009/0089618 A1
(43) Pub. Date: Apr. 2, 2009

(54) System and Method for Providing Automatic Test Generation for Web Applications

(75) Inventors: Sreeranga P. Rajan, Sunnyvale, CA (US); Praveen Kumar Murthy, Fremont, CA (US)

Correspondence Address: BAKER BOTTS L.L.P., 2001 ROSS AVENUE, SUITE 600, DALLAS, TX, 75201-2980, US

(73) Assignee: Fujitsu Limited, Kawasaki-shi (JP)

(21) Appl. No.: 11/865,413

(22) Filed: Oct. 1, 2007

(51) Int. Cl. G06F 11/34

(52) U.S. Cl. 714/33; 714/E11.197

(57) ABSTRACT

In accordance with a particular embodiment of the present invention, a method is offered that includes generating an automatic test case generation using model checking for web applications, the automatic test case generation including: developing a specification; verifying a property using model checking on the specification; obtaining a counterexample, whereby the counterexample is mapped to a web test case; and executing the web test case on an implementation. In more specific embodiments, the method includes generating counterexamples by negating a desirable property and then model checking the specification, whereby the counterexamples represent a set of witnesses that are mapped to the web test case; and executing the web test case on the implementation. In still other specific embodiments, the generating step and the executing step are repeated on available properties and on their available counterexamples. The witnesses can be mapped to the web test case through selected framework technology.

### TECHNICAL FIELD OF THE INVENTION

This invention relates generally to the field of web applications and, more specifically, to a system and a method for providing automatic test generation for web applications.

### BACKGROUND OF THE INVENTION

For most web applications, existing implementations may contain errors, such as the user database not being updated correctly even after a user registers, or a shopping cart not being emptied even after the user checks out, and so forth. The errors could pertain to only internal behaviors and, further, be difficult to identify. As we naturally consider formal methods for testing legacy web applications, an immediate challenge is that formal verification may not be feasible by default. Indeed, a legacy application may be lacking a high-level specification, which is a key ingredient of verification. In addition, verification at the source code level is likely to be difficult by nature, potentially unscalable, and platform-dependent: especially so in the case of web applications.

Typically, testing the implementation can help identify errors. However, it is also easy to see that it is challenging to construct effective tests. Existing work on testing legacy web applications tends to require the tester to have expert knowledge about low-level details of the implementation. In addition, propositional abstraction, (i.e. abstracting the application using propositions) is still commonly used, but this is far from ideal. Inspired by frameworks for specification and verification of data-driven web applications, the goal of many designers' work is to explore how data-aware verification can be used to facilitate necessary testing.

Therefore, the ability to solve testing issues in web applications creates an interesting challenge. As with all such processing operations, of critical importance are issues relating to speed, accuracy, and automation.

### SUMMARY OF THE INVENTION

The present invention provides a method and a system for providing an effective test generation for web applications that substantially eliminates or reduces at least some of the disadvantages and problems associated with previous methods and systems.

In accordance with a particular embodiment of the present invention, a method is offered that includes generating an automatic test case generation using model checking for web applications, the automatic test case generation including: developing a specification; verifying a property using model checking on the specification; obtaining a counterexample, whereby the counterexample is mapped to a web test case; and executing the web test case on an implementation.

In more specific embodiments, the method includes generating counterexamples by negating a desirable property and then model checking the specification, whereby the counterexamples represent a set of witnesses that are mapped to the web test case; and executing the web test case on the implementation.

In still other specific embodiments, the generating step and the executing step are repeated on available properties and on their available counterexamples. The witnesses are mapped to the web test case, whereby the mapping includes mapping abstract witness runs to execution-ready tests in a native language of the web application. The mapping can be executed through selected framework technology. Test suites can be generated based on scenario analysis and coverage of a model that provably covers the specification, the test suites being used in addition to a user-defined property-based witness suite.

In still other specific embodiments, if the web test case fails, it indicates that there is a problem with the implementation. If the web test case fails, the specification has an error. If the web test case passes, design logic of the web application includes a flaw. Assertions can be automatically generated and inserted in test monitor code. A tester can modify the specification based on results of the web test case.

The automatic test case generation utilizes user-defined properties. The specification can be refined after developing the specification and executing the web test case on the implementation.

Technical advantages of particular embodiments of the present invention include providing a complete validation solution. Specifically, the present invention combines formal specification, reverse-engineering techniques [e.g., code analysis, model checking, scenario generation, and execution-ready code generation from witnesses and scenarios] to provide a complete validation solution for legacy web applications. In contrast, previous work has failed to successfully or credibly provide such a synergistic methodology. The test generation methodology of the proposed architecture produces tests based on both.

In addition, it should be appreciated that the configuration of the present invention is automatic. There is no reason to have a developer write lengthy code for testing. Assertions are automatically generated and inserted in test monitor code. Moreover, user-defined properties (e.g., shopping cart must be empty after check out) are articulated. In addition, comprehensive scenario analysis of specification models is performed with relative ease.

Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 is a simplified block diagram illustrating an example model checker and symbolic execution related to one embodiment of the present invention;

FIG. 2 is a simplified block diagram illustrating an example model checking driven test generation scenario; and

FIG. 3 is a simplified block diagram illustrating an example model-based web test case generator in accordance with one embodiment of the present invention.

### DETAILED DESCRIPTION OF THE INVENTION

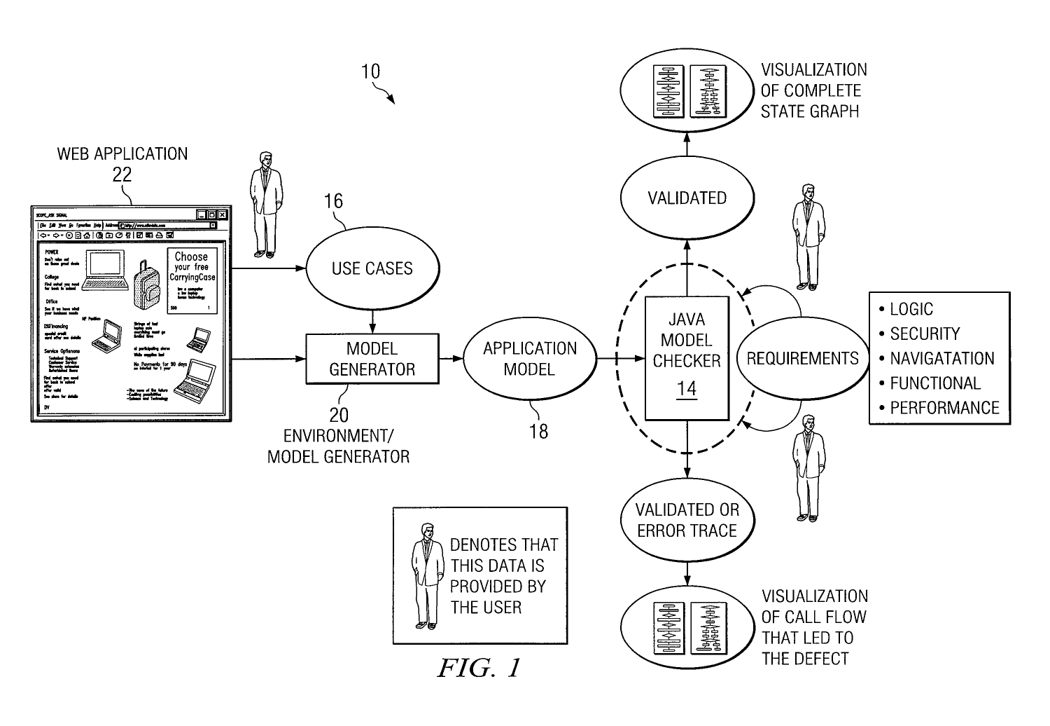

FIG. 1 is a simplified block diagram illustrating an example model checker and symbolic execution system 10 related to one embodiment of the present invention. FIG. 1 can represent an example flow: detailing a typical user-level application of a validation web services architecture. FIG. 1 includes a Java model checker 14, a set of use cases 16, an application model 18, an environment/model generator 20, and a web application 22. The requirements component of FIG. 1 (which interfaces with Java model checker 14) can be further separated into logic, security, navigation, functional, and performance issues.

In accordance with the teachings of example embodiments of the present invention, the architecture presented offers an ideal test generation solution for web applications. As an initial matter, it should be appreciated that the architecture proffered herein is targeted toward web applications, where existing implementations contain errors, such as the user database not being updated correctly even after a user registers, or a shopping cart not being emptied even after user checks out, etc. The errors could pertain to only internal behaviors and be difficult to identify. As formal methods for testing legacy web applications are considered, an immediate challenge is evident: formal verification may not be feasible by default. Indeed, a legacy application may be lacking a high-level specification, which is a key ingredient of verification. In addition, verification at the source code level is likely to be difficult by nature, unscalable, and platform-dependent, especially so in the case of web applications.

Commonly, testing an implementation can help identify errors. However, it is readily apparent to conclude that it is non-trivial to construct effective tests. Existing work on testing legacy web applications tends to require the tester to have expert knowledge about low-level details of the implementation. In addition, propositional abstraction, i.e. abstracting the application using propositions, is still commonly used. Inspired by frameworks for specification and verification of data-driven web applications, one goal of the system detailed herein is to examine and resolve how data-aware verification can be used to facilitate testing.

One framework proposed a paradigm in which the web-application developer starts with a high-level specification of the application, performs verification by checking various properties, and eventually obtains an automatically generated implementation of the application. In the testing paradigm proposed here, as touched on above, the tester starts with the existing implementation. At the first sight, this appears to present a significant mismatch. However, a key observation is that verification results output by the framework have a close relationship with actual tests. Indeed, when a given property is false, the verifier will display a sequence of interactions between the user and the web application, which represents a violation of the property (known as a counterexample).

Before describing an ideal approach for testing web applications, an understanding of web test cases is helpful. A web test case is a specialized program that performs user inputs and navigations on actual web sites, as well as making assertions during the process. A web test case is said to ‘pass’ if it represents a valid execution of the web site [with all assertions being true] and is said to ‘fail’ otherwise. In some embodiments, web test cases are in forms of Java programs using JWebUnit libraries.

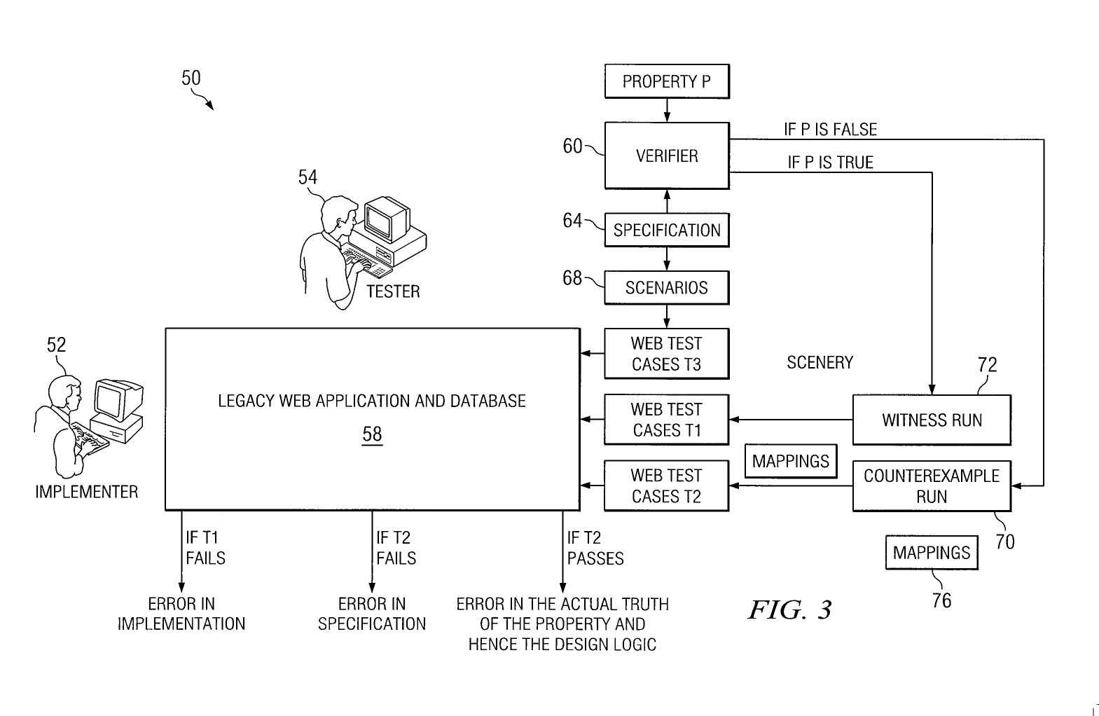

Against this backdrop, the resultant architecture of the present invention offers a methodology in which a verification-based testing approach is implemented. First, it is noted that the implementer of the application is likely to be different from the tester, whom now produces a high-level specification of the application and desirable properties to be verified. This immediately presents a couple of potential problems: 1) There is no guarantee that the specification (written by the tester [as shown in FIG. 3]) is faithful with respect to the implementation (written by the implementer); and 2) There might be flaws in the design logic of web application. In addition to the original problem, there may be errors in the implementation.

The approach presented herein consists of two stages. In the first stage, the specification is developed and refined. The specification is developed in a variety of ways. For example, the tester can look at the implementation and manually create a framework, or unified modeling language (UML) type of models. Automated code analysis tools can be used to reverse engineer the code base to produce UML-type of models. Server logs and network traffic analysis can be used to construct scenarios and use cases of how web pages are typically traversed. Once the specification model has been developed, a property is verified using model checking on the specification model using standard techniques and a counterexample is obtained and mapped to a web test case. The web test case is executed on the implementation. If it fails, problem #1 described above is identified; if it passes, problem #2 from above is identified. In either case, the tester modifies the specification as necessary and appropriate. This process is repeated on all available properties and all their counterexamples that are available.

By the end of stage one, the specification has been refined in all available ways and, therefore, the tester freezes it (and trusts it) and focuses on the original problem of identifying errors in the implementation. The goal in this phase is to generate a comprehensive suite of test cases that can catch as many errors in the implementation as possible. This can be resolved in two different ways.

For the first method, since any desirable property is true on the specification at this stage, counterexamples are generated by negating this desirable property and then model checking the specification. Since the property holds on the specification, its negation does not, and a counterexample (a witness) is yielded. This witness is mapped to a web test case. Technology can be used to enable this type of mapping, where abstract witness runs can be mapped to actual execution-ready tests in the native language of the web application. As before, the web test case is executed on the implementation. If it fails, one problem highlighted above is identified, in which case the tester attempts to fix the error in the implementation. This process is repeated on all available properties and all their witnesses available.

A second method for generating test suites uses technology to generate general test suites based on scenario analysis and coverage of the model that provably covers the entire specification. This set of test suites can be used in addition to the user-defined property-based witness suite generated above. The combination of these two test suites will ensure both scenario coverage and coverage of key properties.

Such a framework offers a new approach for testing legacy web applications. The approach can be based on data-aware verification powered by a framework, and requires little knowledge about low-level details and no abstraction. This provides a number of salient advantages. For example, this protocol combines formal specification, reverse-engineering techniques [e.g., code analysis, model checking, scenario generation, and execution-ready code generation from witnesses and scenarios] to provide a complete validation solution for legacy web applications. In contrast, previous work has failed to successfully [or credibly] provide such a synergistic methodology. The test generation methodology of the proposed architecture produces tests based on both.

Moreover, the configuration of the present invention is automatic. There is no reason to ask a developer to write lengthy code for testing. Assertions are automatically generated and inserted in test monitor code. Moreover, user-defined properties (shopping cart must be empty after check out) are articulated. In addition, comprehensive scenario analysis of specification models is preformed with relative ease.

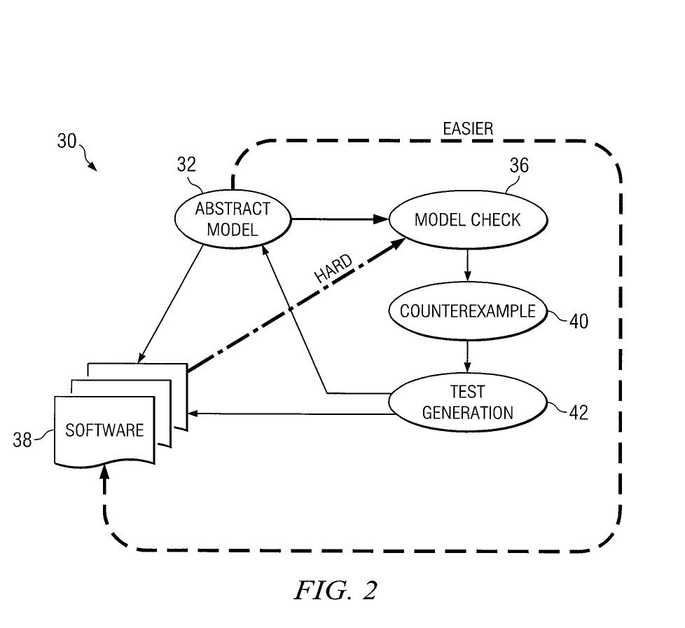

FIG. 2 is a simplified block diagram illustrating an example system 30 for model checking driven test generation. FIG. 2 includes an abstract model 32, a test generation component 42, a counterexample 40, a model check 36, and a software component 38. Note that inherent simplicity or distinctions being made between an ‘easy’ solution and a more complicated, or ‘hard’ solution that implicates abstract model 32.

In regards to testing, the target is generally web applications. Existing implementations often contain errors. For example, one error could be a shopping cart that is not emptied even after a user checks out. The challenge, succinctly stated, is: formal verification is not feasible by default. Nothing exists for a high-level specification that is suitable for formal verification. Also, verifying the source code is likely to be difficult by nature and platform-dependent.

Testing the implementation can identify errors. The challenge relevant here is: It is difficult to construct effective tests in such scenarios. Existing work tends to require the tester to have expert knowledge about low-level details of the implementation. Propositional abstraction is still commonly used. The goal is to use data-aware verification to facilitate testing.

There are two aspects of the idea: 1) generating test cases for the implementation itself; and 2) generating test cases for the specification. As a designer, you are checking whether the implementation corresponds to the specification, or whether the specification itself is correct. What should be assured is: 1) the specification is correct; and 2) the implementation satisfies the specification. When these two are correct, then the implementation, inferentially, is correct.

The present invention can start with existing implementations. One issue addresses how to identify errors in the implementation. In terms of verification-based testing, testing seems to be necessary for legacy web applications. The challenge is to come up with effective tests, which help identify errors.

Embodiments of the present invention essentially combine testing with verification. Verification can be used to facilitate testing. A key observation: verification results (i.e. counterexample runs) can have close relationships with actual tests. Now, technology can be employed to generate actual tests that can be simulated against the implementation (instead of just a model).

FIG. 3 is a simplified block diagram illustrating an example model-based web test case generation. FIG. 3 includes a tester 50, an implementer 52, a legacy web application and DB component 58, a verifier 60, a scenarios component 68, a specification 64, a counterexample run 70, a witness run 72, and a mappings component 76.

In this scenario, if T1 fails, this would indicate an error in the implementation. If T2 fails, this would indicate an error in the specification. If T2 passes, there is an error in the actual truth of the property and, hence, the design logic.

In terms of model-based web test case generation arrangements, at stage 1, there the specification is adapted. Then, the property on the specification is verified. Subsequently, a counterexample run (until none exists) is obtained and this is mapped to a web test case. A test case on the implementation is executed. The specification is modified as necessary and then the above process is repeated.

At stage 2, the implementation is fixed. Here, the idea is to freeze the specification (and trust it). A witness run of the property is obtained. This is mapped to a web test case. The next step is to execute a test case on the implementation. If the test case fails, errors in implementation are fixed. The above process is then repeated.

For the test generation, whatever form the specification is in (UML, state machine, etc.), this is translated to a model (hierarchical message sequence charts). Witness run properties are also obtained on this model. The code generation technology can be used to generate simulation-ready test cases that can be used against the implementation directly.

Using such processes, a complete test generation methodology is achieved. The tester can test specific properties and the tester can negate passing properties (on model) to generate counterexamples that can be tested against implementation. In addition, the tester can generate a complete suite of tests based on all possible scenarios from the model and use cases. Assertions are automatically generated and inserted in test monitor code. A complete testing environment can be used that combines and leverages diverse technologies to provide a complete validation solution.

It is critical to note that the components illustrated in FIGS. 1, 2, and 3 may be implemented as digital circuits, analog circuits, software, or any suitable combination of these elements. In addition, any of these illustrated components may include software and/or an algorithm to effectuate their features and/or applications as described herein. The software can execute code such that the functions outlined herein can be performed. Alternatively, such operations and techniques may be achieved by any suitable hardware, component, device, application specific integrated circuit (ASIC), additional software, field programmable gate array (FPGA), processor, erasable programmable ROM (EPROM), electrically erasable programmable ROM (EEPROM), or any other suitable object that is operable to facilitate such operations. Considerable flexibility is provided by the structure of these architectures in the context of this arrangement. Thus, it can be easily appreciated that such functions could be provided external to the outlined environment. In such cases, such a functionality could be readily embodied in a separate component, device, or module.

Although the present invention has been described in detail with specific components being identified, various changes and modifications may be suggested to one skilled in the art and, further, it is intended that the present invention encompass any such changes and modifications as clearly falling within the scope of the appended claims.

Note also that, with respect to specific process flows disclosed, any steps discussed within the flows may be modified, augmented, or omitted without departing from the scope of the invention. Additionally, steps may be performed in any suitable order, or concurrently, without departing from the scope of the invention.

Numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. A method, comprising:
generating an automatic test case generation using model checking for web applications, the automatic test case generation including:
developing a specification;
verifying a property using model checking on the specification;
obtaining a counterexample, whereby the counterexample is mapped to a web test case; and
executing the web test case on an implementation.

2. The method of claim 1, further comprising:
generating counterexamples by negating a desirable property and then model checking the specification, whereby the counterexamples represent a set of witnesses that are mapped to the web test case; and
executing the web test case on the implementation.

3. The method of claim 2, wherein the generating step and the immediately following executing step are repeated on available properties and on their available counterexamples.

4. The method of claim 2, further comprising:
mapping the witnesses to the web test case, whereby the mapping includes mapping abstract witness runs to execution-ready tests in a native language of the web application.

5. The method of claim 4, wherein the mapping is executed through selected framework technology.

6. The method of claim 1, wherein test suites are generated based on scenario analysis and coverage of a model that provably covers the specification, the test suites being used in addition to a user-defined property-based witness suite.

7. The method of claim 1, wherein if the web test case fails, it indicates that there is a problem with the implementation.

8. The method of claim 1, wherein if the web test case fails, the specification has an error.

9. The method of claim 1, wherein if the web test case passes, design logic of the web application includes a flaw.

10. The method of claim 1, wherein assertions are automatically generated and inserted in test monitor code, and wherein a tester modifies the specification based on results of the web test case.

11. The method of claim 1, wherein the automatic test case generation utilizes user-defined properties.

12. The method of claim 1, further comprising:
refining the specification after developing the specification and executing the web test case on the implementation.

13. Logic embedded in a computer medium and operable to:
generate an automatic test case generation using model checking for web applications, the automatic test case generation including:
developing a specification;
verifying a property using model checking on the specification;
obtaining a counterexample, whereby the counterexample is mapped to a web test case; and
executing the web test case on an implementation.

14. The logic of claim 13, further operable to:
generate counterexamples by negating a desirable property and then model checking the specification, whereby the counterexamples represent a set of witnesses that are mapped to the web test case; and
execute the web test case on the implementation.

15. The logic of claim 14, wherein the generating step and the immediately following executing step are repeated on available properties and on their available counterexamples.

16. The logic of claim 14, further operable to:
map the witnesses to the web test case, whereby the mapping includes mapping abstract witness runs to execution-ready tests in a native language of the web application.

17. The logic of claim 16, wherein the mapping is executed through selected framework technology.

18. The logic of claim 13, wherein test suites are generated based on scenario analysis and coverage of a model that provably covers the specification, the test suites being used in addition to a user-defined property-based witness suite.

19. The logic of claim 13, wherein if the web test case fails, it indicates that there is a problem with the implementation.

20. The logic of claim 13, wherein if the web test case fails, the specification has an error.

21. The logic of claim 13, wherein if the web test case passes, design logic of the web application includes a flaw.

22. The logic of claim 13, wherein assertions are automatically generated and inserted in test monitor code, and wherein a tester modifies the specification based on results of the web test case.

23. The logic of claim 13, wherein the automatic test case generation utilizes user-defined properties.

24. The logic of claim 13, further operable to:
refine the specification after developing the specification and executing the web test case on the implementation.
